(19) United States
(12) Patent Application Publication
(10) Pub. No.: US 2003/0081001 A1
(43) Pub. Date: May 1, 2003

(54) Computer-assisted deletion of received electronic messages

(76) Inventor: Michael W. Munro, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/003,889

(22) Filed: Oct. 25, 2001

(51) Int. Cl. G09G 5/00

(52) U.S. Cl. 345/752

(57) ABSTRACT

A method for computer-assisted deletion of electronic messages is disclosed. The method comprises searching content of an outgoing electronic message for a date. The method continues with including an expiration date to be sent in addition to the message content, wherein the expiration date is related to the date determined from the content of the electronic message. The method further includes sending the outgoing electronic message to a recipient.

### BACKGROUND OF THE INVENTION

The invention relates to the management of electronically generated messages and, more particularly, to date-sensitive messages that are used, for example, in electronic messaging programs such as electronic mail.

As the popularity of electronic messaging programs such as electronic mail continues to increase, the need for storage of messages generated by these programs also increases. As a result of these increasing storage demands, individuals and businesses must continually increase the resources allocated for the storage of sent and received electronic messages. Further, since many of these messages are date-sensitive or time-critical, these stored messages are of diminished value as the messages are stored past the applicable calendar date.

In at least one currently available electronic mail program, a sender of an electronic mail message can specify the expiration date of the electronic mail. Thus, when the message is received and stored, the receiving user can be informed when the expiration date of the message has passed. The receiving user can then elect to delete the message, thus making memory storage resources available for storing other information. However, in order for the receiving user to benefit from this strategy, the expiration date must be entered by way of a sender manually entering an expiration date by way of a dialog box. This can become overly burdensome and thus detract from the convenience of using the electronic mail program.

Thus, it is highly desirable for an electronic messaging program to delete expired messages without substantial input from either the sender or the receiver of the message.

### BRIEF DESCRIPTION OF THE DRAWINGS

FIGS. 1A-1B is a flowchart of a method for the deletion of date-sensitive messages in an electronic messaging program in accordance with a preferred embodiment of the invention.

FIG. 2 is a block diagram of a system that performs the deletion of date-sensitive messages in an electronic messaging program in accordance with a preferred embodiment of the invention.

### DESCRIPTION OF THE PREFERRED EMBODIMENTS

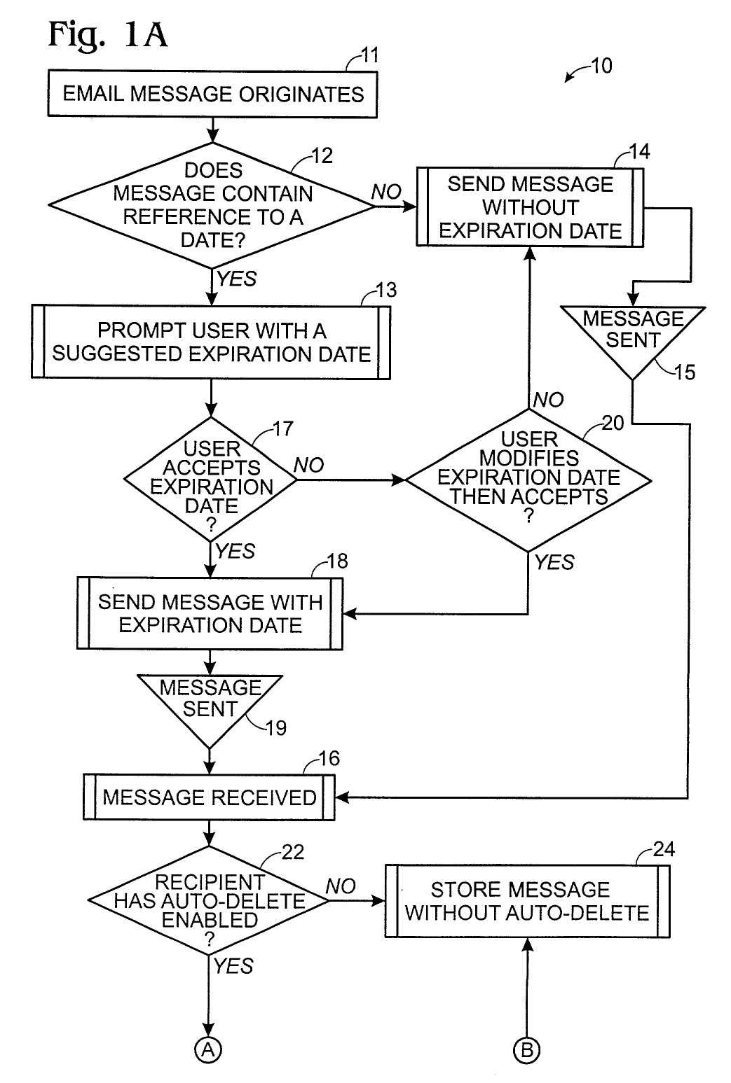

FIGS. 1A-1B is a flowchart (10) of a method for the management of date-sensitive messages in an electronic messaging program in accordance with a preferred embodiment of the invention. Although the flowchart of FIG. 1 specifically refers to an electronic mail program, the flowchart can be applied to other electronic messaging programs such as Short Messaging Service, which enables users to send electronic messages through the control channel of a cellular communications system. These messages are generated, transmitted, received, processed, and displayed by way of a sender and a receiver interacting with cellular telephones or other mobile radio equipment that include an electronic messaging capability.

The method of FIG. 1 begins at block 11 in which an electronic mail message originates at a first user's computer system. In a preferred embodiment, block 12 involves the use of a searching module that examines the content of the message in order to provide a suggested date at which the electronic mail message should be deleted by the recipient of the message. Desirably, the reference to the date is included within the portion of the message entered by the user. Alternatively, the date reference is included within the entire confines of the electronic mail message, which includes the user-entered portion of the message as well as in any attachment to the user-entered portion of the message. In either case, the expiration date suggested as a result of searching the content of the message for date information is appended to or inserted within the outgoing electronic mail message. Preferably, the date information is inserted into or attached to the message according to a format that is compatible with a variety of electronic mail or messaging programs, thus allowing the date information to be received and interpreted by the various other electronic mail and messaging programs.

If the decision of block 12 indicates that the electronic mail message includes a reference to a date, the method continues at block 13 in which the user is prompted with a suggested expiration date. In the event that two or more dates are present within the message or within an attachment, block 13 can prompt the user to select between two or more dates, if needed. Further, any date presented to the user at block 13 need not be coincident with the date information found within the outgoing electronic mail message. For example, block 13 can present the user with a date that is one day, two days, one week (and so forth) subsequent to a date found within the outgoing message.

At decision point 17 the user is given the option of accepting or confirming the suggested expiration date, thus allowing the user to correct an expiration date that has been improperly entered. This can be executed by way of a dialog box being presented to the user or by way of another indication. If the user accepts the expiration date, the method proceeds to block 18 in which the message is sent with the suggested expiration date. In the event that the user has been prompted (in block 13) to select from among two or more expiration dates, the message is sent along with the user-selected expiration date. If the user does not accept the expiration date, which may occur if an incorrect expiration date has been presented to the user, the method continues at block 20, in which the user is given an opportunity to enter an expiration date. After the user accepts the suggested expiration date, the method proceeds to block 18 and the message is sent to the recipient along with the suggested expiration date (in block 19).

If, at block 20, the user does not wish to modify the expiration date, indicating that the suggested expiration is correct, the method proceeds to block 18 in which the message is sent with the expiration date. Block 18 is followed by block 19 where the message is transmitted across an appropriate network or other portion of a communications infrastructure.

Returning to the decision of block 12, if a date reference is not found within the message, the method continues at block 14 in which the message is sent without an expiration date. The electronic mail messaging program then sends the message across a portion of a communications infrastructure in block 15. The method proceeds to block 16, in which the recipient receives the message.

At block 16, the electronic mail message is received. The method continues at block 22, wherein a determination is made as to whether the receiving computer system has an automatic expiration date feature enabled. If the receiving system does not have an expiration date feature enabled, the method proceeds to block 24 in which the message is stored without an expiration date, and thus is not subject to being automatically deleted.

If the decision of block 16 indicates that the receiving computer has an automatic deletion feature enabled, the method continues at step 23 in which the receiving computer determines if the received message includes an expiration date. If an expiration date has not been included, the method continues at step 24 where the message is stored without reference to an expiration date. If, however, the message includes an expiration date, the method proceeds to block 26 in which the message is stored with the expiration date, and is thus subject to being automatically deleted when the expiration date has been reached. At block 25, the message is examined at preferably regular intervals to determine if the message should be deleted based on a comparison of a current date with the expiration date associated with the message. If the expiration date has passed, the message is deleted in block 27.

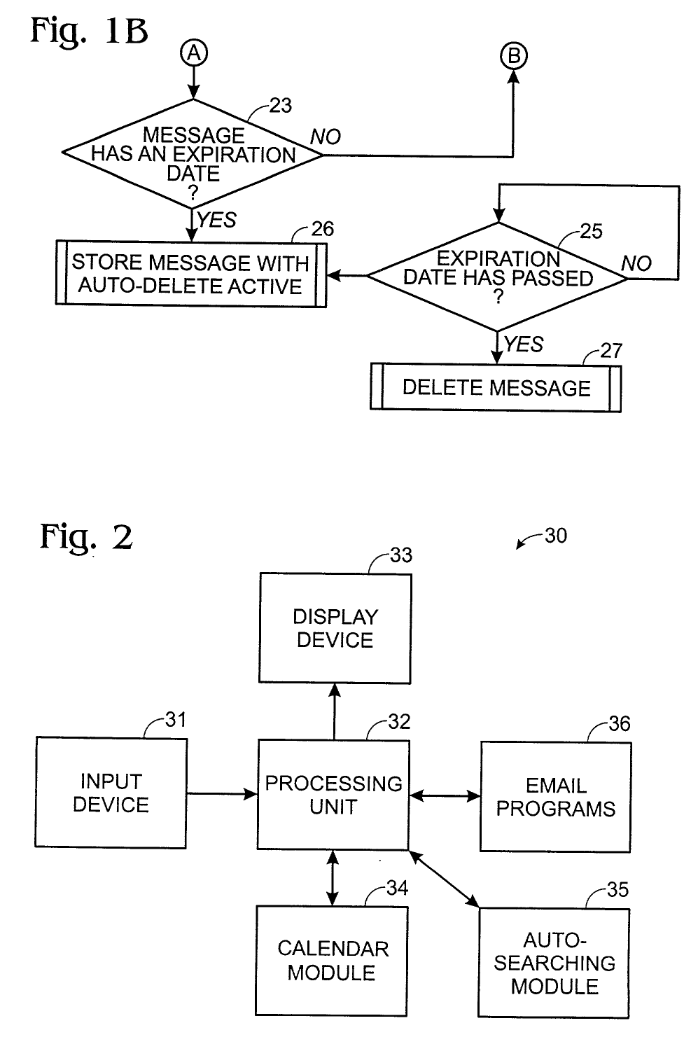

FIG. 2 is a diagram of a system that performs the computer-assisted deletion of date-sensitive messages in an electronic mail messaging program in accordance with a preferred embodiment of the invention. The hardware and software modules of FIG. 2 represent a computer system that either generates or receives electronic mail messages. In FIG. 2, processing unit 32 interacts with calendar 34, electronic mail messaging program 36, auto-searching module 35, input device 31, and display device 33. Preferably, a user enters an electronic mail message that includes at least one date reference using input device 31. Input device 31, which can be a keyboard, mouse, or other data entry device, is used to input data into processing unit 32 that runs electronic mail program 36. Electronic mail program 36 allows the user to transmit, receive, process, and display electronic messages. While interacting with input device 31, the user may also include one or more attachments that may be sent as part of the electronic mail message.

The user-generated message is preferably displayed by way of display 33. When the user has completed entering the electronic mail message (including any attachments), auto-searching module 35 searches the message in order to determine a suggested expiration date, if indeed date information can be found within the message. If more than one date is found by auto-searching module 35, operating in conjunction with calendar module 34, which also runs on processing unit 32, prompts the sending user with at least one suggested expiration date for the message. Desirably, the suggested expiration date (or dates, as the case may be) represents a future date. Preferably, processing unit 32 allows the sender to accept or modify the expiration date by way of input device 31 prior to sending the message to the recipient.

When the message has been received by the receiving computer system, using a system such as that represented by FIG. 2, auto-searching module 35 preferably searches the incoming message for date information that has been appended to or inserted within the received message. In the event that the message includes date information, the message is stored with the attendant date information so that the message can be preferably deleted by processing unit 32 at an appropriate time. In the event that the message does not include date information, or if the receiving computer's utility for the deletion of date-sensitive messages has not been activated by the user, the message is stored without date information.

In an alternate embodiment, if no date information has been attached to, or inserted into the received message, auto-searching module 35 can be used to search the content of the received message in order to determine if date information is present within the received message. This search can be useful in the event that the electronic mail program used to send the message does not include a capability for suggesting an expiration date for the outgoing message or does not include the expiration date information in a format that is compatible with the format expected by the electronic mail program at the receiving side.

Thus, if auto-searching module 35 is able to find date information in the received message, the receiving user can be prompted with a suggested expiration date for the received message. The user can then approve or reject the suggested expiration date. Further, the suggested expiration date does not have to coincide with date information found within the content of the electronic mail message. Rather, the suggested expiration date can be offset from the date information found in the received message by a predetermined offset. Any predetermined offset can be used, such as one day, one week, or longer.

What is claimed is:

1. A method for computer-assisted deletion of electronic messages, comprising:
searching content of an outgoing electronic message for date information;
including an expiration date to be sent in addition to said content, said expiration date being related to said date information from said content of said electronic message; and
sending said outgoing electronic message and said expiration date to a recipient.

2. The method of claim 1, wherein said searching action is performed on a user-entered portion of said electronic message.

3. The method of claim 1, wherein said searching action is performed on an attachment to said user-entered portion of said electronic message.

4. The method of claim 1, wherein said expiration date is appended to said electronic message.

5. The method of claim 1, wherein said expiration date is inserted into said message.

6. The method of claim 1, additionally comprising said recipient receiving said outgoing message and deleting said outgoing message after said expiration date.

7. The method of claim 1, additionally comprising prompting a sender of said outgoing message with said suggested expiration date.

8. The method of claim 7, additionally comprising receiving a confirmation that a sender of said outgoing message accepts said expiration date.

9. A method for the computer-assisted deletion of an electronic message in a computer that receives said electronic message, comprising:
searching said received electronic message for a date, said date being present within the content of said received electronic message;
prompting a user with a suggested expiration date for said received electronic message; and
deleting said received electronic message after said suggested expiration date has passed.

10. The method of claim 9, further comprising a receiving computer user accepting said expiration date for said received electronic message.

11. The method of claim 9, wherein said searching further comprises searching a portion of said received electronic message that has been input by the sender of said electronic message.

12. The method of claim 9, wherein said searching further comprises searching at attachment to said received electronic message.

13. The method of claim 9, wherein said expiration date is offset from said date by a predetermined amount.

14. A system for the computer-assisted deletion of date-sensitive messages in an electronic messaging program, comprising:
an input device that conveys inputs from a user to a processing unit;
an electronic messaging program that runs on said processing unit, said electronic messaging program allowing the user to construct electronic messages based on inputs from said input device; and
an auto-searching module that searches within said electronic message for date information, said auto-searching module also suggesting an expiration date of said electronic message based on said date information.

15. The system of claim 14, wherein said electronic messaging program also allows said user to include an attachment in said electronic message, and wherein said auto-searching module additionally searches within said attachment for said date information.

16. The system of claim 17, wherein said input device is a keyboard.

17. A system for the computer-assisted deletion of date-sensitive messages in an electronic messaging program, comprising:
an electronic messaging program that runs on a processing unit, said electronic messaging program receiving electronic messages from a sender; and
an auto-searching module that searches said electronic messages for date information, said auto-searching module suggesting an expiration date based on said date information.

18. The system of claim 17, wherein said auto-searching module additionally stores a second electronic message if said second electronic message includes an expiration date that has been accepted by the sender of said second electronic message.

19. The system of claim 17, wherein said processing unit deletes said electronic message after said expiration date has passed.

20. The system of claim 17, wherein said auto-searching module searches for date information within an attachment included within said electronic message.
